(19) United States
(12) Patent Application Publication
(10) Pub. No.: US 2017/0144388 A1
(43) Pub. Date: May 25, 2017

(54) Moulded Product for Automotive Panels

(71) Applicant: Autoneum Management AG, Winterthur (CH)

(72) Inventors: Pierre DANIERE, Rorbas (CH); Philippe GODANO, Winterthur (CH); Wenzel KRAUSE, Winterthur (CH); Stefan KÖNIGBAUER, Winterthur (CH)

(73) Assignee: Autoneum Management AG, Winterthur (CH)

(21) Appl. No.: 15/416,708

(22) Filed: Jan. 26, 2017

Related U.S. Application Data
(62) Division of application No. 13/379,115, filed on Dec. 19, 2011.

(30) Foreign Application Priority Data
Sep. 16, 2009 (CH) 01433/09
Sep. 17, 2009 (EP) 09011844.9

(51) Int. Cl. B29C 70/46; B29C 70/54; B29C 70/06

(52) U.S. Cl. CPC B29C 70/465; B29C 70/06; B29C 70/54; B29K 2077/00

(57) ABSTRACT

Composite molded product comprising of at least one polyamide-reinforcement layer consisting of a polyamide matrix and reinforcement fibers, characterised in that the polyamide-reinforcement layer is porous due to the consolidation using a pressurised steam process.

This application is a divisional of U.S. patent application Ser. No. 13/379,115, filed Dec. 19, 2011, which is a U.S. National Phase of PCT/EP2010/063374, filed Sep. 13, 2010, which claims the benefit of priority to Swiss Patent Application No. 01433/09, filed Sep. 16, 2009 and European Patent Application No. 09011844.9, filed Sep. 17, 2009, the foregoing being incorporated by reference herein.

### TECHNICAL FIELD

The invention relates to molded product and the method of producing it.

### BACKGROUND

In the automotive industry, structural panels are used in a wide variety of applications where high strength and lightweight are required. Molded reinforced panels are particularly for use in an automotive vehicle as for instance a parcel shelf, ceiling cover, engine bay panels or load floor as well as for panels used at the outside of a car like an under-engine shields or outer wheel arch liner. Additional acoustic properties for the attenuation of noise can be a requirement, in particularly the sound absorption factor of the material. For instance, composite panels, eventually with a honeycomb core, are used in trim parts, sunroof panels, hard tops, parcel shelves, spare wheel covers and luggage floor assemblies. Depending on the material chosen, they can also be used as under floor, engine or engine-bay cover. Fiber reinforced composites are used as the main material or as a skin layer for these products, sometimes combined with additional layers for specific purposes.

Composite materials (or composites for short) are engineered materials made from two or more constituent materials with significantly different physical or chemical properties, which remain separate and distinct on a microscopic level within the finished structure.

Composites are made up of individual materials referred to as constituent materials.

There are two categories of constituent materials: Matrix and reinforcement. At least one portion of each type is required. The matrix material surrounds and supports the reinforcement materials by maintaining their relative positions. The reinforcements impart their special mechanical and physical properties to enhance the matrix properties. A synergism produces material properties unavailable from the individual constituent materials. Engineered composite materials must be formed to shape. The matrix material can be introduced to the reinforcement before or after the reinforcement material is placed into the mold cavity or onto the mold surface. The matrix material experiences a change in physical state, for instance for thermoplastic material a melting event, after which the part shape is essentially set. Depending upon the nature of the matrix material, this change in physical state can occur in various ways such as chemical polymerisation (duroplast) or solidification from the molten state (thermoplastic).

Most commercially produced composites use a polymer matrix material often called a resin solution. There are many different polymers available depending upon the starting raw ingredients. There are several broad categories, each with numerous variations. The most common are known as polyester, vinyl ester, epoxy, phenolic, polyimide, polyamide, polypropylene, PEEK, and others. The reinforcement materials are often fibers, but also commonly ground minerals. Composite material can be made by using a layer or mat of fibrous material at least partially consisting of reinforcing fibers like glass fibers, and a binder material, either in form of a powder, a liquid solution or as binder fibers. The materials are mixed and cured, normally by heat molding the material in a molding press producing directly the wanted product form.

US20050214465 discloses a process for producing a composite using polyamide as a matrix whereby the reinforcing materials are impregnated with a lactam melt activated for anionic polymerisation and afterwards heated. Another known process is the pultrusion process. The material produced can be granulated and later used in injection molding or extrusion methods.

Another technique used is mixing the reinforcement fibers with the thermoplastic melt. Also, here mostly followed by injection molding eventually followed by press molding to obtain the desired form of the products.

The use of a thermoplastic melt or impregnation with a melt renders the product obtained compact and non-porous, as the melt will fill up the spaces between the reinforcing material and close all existing pores.

U.S. Pat. No. 7,132,025 discloses a process using thermoplastic fibers as matrix material. These fibers are first blended with the reinforcing fibers and then dry-laid to give a blended web. The web is than consolidated with needling, heated and compacted to give the final product. The web is heated to a temperature above the softening point of the thermoplastic fibers using a conventional oven or by IR radiation and directly compressed to provide a compressed and partially consolidated thermo-formable semi-finished product.

US20050140059 discloses a process of producing molded parts made of fibers whereby the fibers are first heated between plates and then subjected to compression molding, using additionally air suction to obtain a better-shaped product. The fibers used are bicomponent fibers as binder fibers and other fibers like reprocessed cotton and polypropylene as the bulk fibers. Although the use of high-pressure steam or fluid air as alternatives for the heating of the material before compression molding are mentioned in the introduction, the actual disclosed process only uses heated plates to obtain 200° C. for one minute to heat and consolidate the fibrous material. The use of steam is not disclosed in combination with the used materials and the disclosed process.

WO2004098879 discloses a method of producing a composite material of a mixture of thermoplastic fibers and reinforcement fibers using a needled nonwoven web as the starting material. This web is combined with dual foils with a high melting and a lower melting thermoplastic material. The layered stack is than heated, using either IR-waves or hot air, up to such a temperature, that the thermoplastic fibers and the low melting thermoplastic material of the foil are heated above their melting temperature for a short time, long enough to enable a softening. Directly afterwards the layered material is pressed, for instance using rollers. The patent discloses as an example a combination of Polyamide-6 as the binder fiber and glass- and PET fibers as the reinforcement fibers.

Also, WO2007000225 discloses a method of producing a stiff part using a combination of low and high melting fibers, whereby the fiber web is heated above the melting temperature of the low melting fibers. The application further discloses the use of glass fibers or polyester fibers as high melting fibers and polypropylene or polyester as low melting fibers in a core material. This core material is layered between 2 outer thermoplastic foil layers. During the heating step the inner core material is expanding because of inner pressure in the fibers of the core, giving a lofting effect to the overall material. The final product contains partly highly compressed areas and partly this lofted areas. In practice, this is done with a combination of polypropylene and glass fibers and is called soft lofting.

A disadvantage of the state of the art is the high temperature needed to obtain the final composite. The heating temperature to be achieved is dependent on the matrix polymer. To form the composite, the matrix and reinforcement fibers are heated using a dry heating method like hot air, contact heating or infrared heating. The product is normally heated above the true melting point of the matrix polymer to compensate for the temperature loss for instance from the heating device to the molding device. Heating of a polymer above the melting point accelerates degradation.

Using a contact heater has the additional disadvantage that the product has to be compressed to obtain a good transfer of heat throughout the thickness of the product. Hot air is normally used at a temperature above the melting temperature of the binder polymer thus the polymer gets heat damaged, while the use of infrared heating is only feasible for thin materials. In thicker materials, the amount of energy needed to heat the inner core is damaging for the outer surface polymers. This method is normally used only for a thickness up till 4-5 mm.

Another disadvantage is the fact that most thermoplastic polymers used as matrix fibers and as reinforcement fibers have their melting temperature close to each other for instance the melting temperature of poly ethylene terepthalate (PET) is in the range of 230-260° C., for polypropylene between 140-170° C., for Polyamide-6 between 170-225° C. and for Polyamide-6.6 between 220-260° C. Using matrix fibers and reinforcement fibers both being thermoplastic polymers, for instance PA6.6 as matrix and PET as reinforcement, having to heat them above the melting temperature of the matrix fibers will also cause the reinforcement fibers to start melting or softening. This will lead to a collapse of the structure, forming a very compact composite.

The felts are widely used particularly in automotive industry for their thermal and acoustic insulation properties. The trend is towards recyclable materials; therefore, thermoplastic binders have taken a significant share in the last years. Fibers made of high performance polymers such as polyesters, polyamide are highly interesting due to their mechanical and heat resistance properties. But the necessary binding agent form the limitation to their utilization in molded 3D parts.

The binding agents used so far always have a lower melting point than the reinforcement fibers, rendering in relatively weak performance behaviour to the molded fiber web and limiting its utilization to tempered areas in the vehicle. None of these types of molded fiber webs is suitable for the high temperature exposure of the engine bay or compartment, particularly of the engine contact areas. Some of these binders are modified polymers (CO-PET as an example) having pour behaviours due to their modified structure particularly sensitive to hydrolysis phenomena.

The processes for molding such felts as known in the state of the art are a “cold” molding process where the felt is pre-heated by various means, and then transferred to a cold mold in which it is compressed in order to get the part shape or a “hot” molding processes, where the felt is introduced in a closed mold, in which a heat transfer media, like air, is introduced for bringing the binding agent to its melting point, and then released. The part is then cooled down, inside the tool or outside, with or without cooling assistance. (See for instance EP1656243, EP1414440, and EP590112).

### BRIEF SUMMARY

It is therefore an object of the invention to find an alternative process to combine matrix and reinforcement fibers without the disadvantages of the current state of the art and to obtain a product that can be used in automotive applications, in particularly also in the engine bay or other areas with high temperatures.

With the composite product of claim 1 comprising of at least one polyamide-reinforcement layer consisting of a polyamide matrix and reinforcement fibers, characterised in that the polyamide-reinforcement layer is porous due to the consolidation of the matrix material in the form of fibers or powder or flakes, and the reinforcement fibers using a pressurised steam process, and the method of claim 8 using a steam process to consolidate a web of polyamide applied in the form of powder, flakes or fibers as matrix, and reinforcement fibers, it is possible to contain the lofty web structure of the reinforcement fibers, obtaining a porous reinforced material. This material has a good dynamic Young's modulus and is heat stable.

A method of preparing a lofty air permeable composite with increased stiffness of randomly disposed binding fibers and reinforcement fibers held together at fiber crossover locations by globules of the thermoplastic resin of the binding fibers has been developed.

In this method, high modulus reinforcing fibers are blended with matrix forming polyamide fibers or with polyamide powder or flakes to form a web by any suitable method such as air lay, wet lay, carding etc. This web is then heated using saturated steam to melt the resin matrix material at a temperature that is lower than the melting temperature of the polymer as measured using Differential scanning calorimetry (DSC) according to ISO11357-3. For example, the melting temperature Tₘ of polyamide-6 (PA-6) is 220° C. as measured using DSC. However, the melting temperature of the same PA-6 in the steam process according to the invention is for example 190° C.

The web is placed in a pressure-resistant mold with at least one steam permeable surfaces. The mold is closed and clamped to withstand the internal pressure. Saturated steam of at least 9 bars absolute is applied to melt the binder. Saturated steam above 20 bars absolute is not economical anymore. Preferably a range of 11 to 15 bars absolute is a good working range. The actual shift of the melting temperature of the polyamide is dependent on the steam pressure generated in the cavity the product is steam molded in. The choice of the pressure used is therefore also dependent on the melting temperature of the reinforcement fibers. For instance, using PA-6 as binder fibers the preferred pressures are 11 bars absolute to 15 bars absolute.

By using steam instead of the usual hot air, hot plates or IR wave it is possible to shift the melting point of Polyamide to a lower temperature using the effect of the water molecules in the steam. The effect of water on polyamide is known and is normally considered a disadvantage; many prior art describes ways to avoid the effect or try to prevent it. Unexpectedly it is just this effect, which makes it possible to combine PA (polyamide) applied in the form of powder, flakes or fibers with other thermoplastic fibers with similar melting points as measured with DSC, like PET (polyester), using PA as the sole binding material, keeping the reinforcement fibers, like PET, in its fibrous form. It is now possible to obtain a heat stable molded product with a porous structure thereby enhancing the acoustic properties, like absorption and airflow resistivity, as well as the thermal conductivity.

The effect of steam is based on a reversible diffusion mechanism. Using Polyamide in form of small fiber diameter or particle size the melting and solidifying is fast and provides short production cycles. Once the steam is released from the mold the Polyamide transforms into the solid state and the part can be demolded as a stiff part. This is an advantage compared to other thermoplastic binders that need to be explicitly cooled inside or outside the mold before obtaining a structural part which is handable.

Because the overall temperature used, can now be kept much lower in comparison with the heating methods without steam, the resilience of the PET fibers is staying intact, leading to a more lofty material. Furthermore, it was found that the binding of the PA was enough to obtain the required stiffness of the final product. Because the PET fibers keep their resilience and the PA molten matrix material only binds the crossing points. The material keeps its lofty appearance due to the void volume in the web. Therefore, the final product will still be air permeable. Furthermore, it was found that also using glass fibers as the reinforcement fibers together with polyamide fibers as the matrix the use of steam is advantageously. Due to the precise regulation of the binding properties less energy is needed for the process, both during heating and during cooling.

In the normal heating process the material is heated up to the melting point of the thermoplastic matrix material. The cooling down of the material is slow due to the slower convection of the heat out of the product and because the material has fallen together due to lack of resilience of the reinforcement fibers and has become compacter. Therefore, the molten condition will continue for a longer period. It is therefore more difficult to regulate the amount of binding. Furthermore, during this cooling period, the material stays floppy because of the longer melted state of the binding matrix and is therefore more difficult to handle. Particularly when handling larger automotive trim part like a headliner or a load floor for a truck or larger vehicle.

Unexpectedly it was also found that as soon as the steam was taken away from the material the process of melting immediately stopped and the material obtained its solid state again. This is an advantage in the ability to reduce production cycle times due to immediately hand able material. The fact that the melting process can be stopped immediately is also a very precise way of regulating the binding properties and therefore the porosity of the material. Which is important for the air permeability properties of the material.

The material used for the polyamide matrix can be in the form of powder, flakes or fibers. However, the use of fibers in combination with reinforcement fibers is the most preferred because fibers mix better and during the handling of the web formed before consolidation the fibers tend to stay in the mixed position. Flakes or powder can fall between the reinforcement fibers out of the web or on the bottom of the forming mold.

As polyamide, all types of polyamide are feasible, particularly CoPA (Copolyamide) Polyamide-6 (PA-6) or Polyamide-6.6 (PA6.6). However also different types of polyamide or a mixture of different types of polyamide will work as a binder according to the invention. It is expected that normal used additives in the basic polyamide recipe are part of the basic polyamide material as claimed, for example chemical compounds to obtain Ultra Violet Resistance.

The reinforcement fibers can be any thermoplastic polymer based material with a melting temperature according to the DSC measurement, which is higher than the melting temperature of the polyamide binder in a steam environment. PET with a melting temperature of between 230-260° C. would work well as a reinforcement fiber. The reinforcement fibers can also be any mineral material, in particularly glass fibers (GF), carbon fibers or basalt fibers. Also, mixtures of both groups of reinforcement fibers can be used, for instance PET together with GF. The choice of material is based on the overall heat stability requirements of the final product and on the price of the individual materials.

The reinforcement fibers can be cut fibers, endless filaments or rovings dependent on the material properties needed.

These and other characteristics of the invention will be clear from the following description of preferential forms, given as non-restrictive examples with references to the attached drawings.

### BRIEF DESCRIPTION OF THE DRAWINGS

FIG. 1 Graph of the dynamic young modulus of different samples.

FIG. 2 Graph of the loss factor of the same samples.

FIG. 3 Comparison of the acoustic absorption of a web consolidated using hot molding plates or the steam process according to the invention.

FIG. 4 Comparison of the thermal conductivity of a web consolidated using hot molding plates or the steam process according to the invention.

### DETAILED DESCRIPTION

For the composites, according to the invention, matrix-forming binder fibers were mixed with reinforcement fibers and carded to form a web. Webs were pre-bonded using needling for handling purposes. (But any kind of pre-bonding processes can be used.) To prevent the composite samples from sticking or solidification to the mold particularly at release of the steam pressure from the tool, a thin nonwoven as surface cover can be used. The nonwoven used does have a neglectable influence on the main features like thickness, acoustic behaviour or stiffness of the final product. The webs for the polyamide-reinforcement layer according to the invention were consolidated using saturated steam as specified.

State of the art samples were compared with polyamide reinforcement layers according to the invention. The state of the art composites were bought according to the availability on the market.

Composite 1 A state of the art composite based on polypropylene as the binder and glass fibers as the reinforcement material, having a density of 881 kg/m³ known in the market as Symalite.

Composite 2 A state of the art felt based material made of bicomponent PET as the binder material and cotton as the reinforcement material having a density of 314 kg/m³.

Composite 3 A composite according to the invention made of 45% PA binder fibers and 55% of glass fibers as the reinforcement fibers. Starting weight of the web was 1000 gram per m². The composite was molded according to the invention using 11 bars absolute of saturated steam for 9 sec. The final density of the formed polyamide reinforcement layer is 384 kg/m³.

Composite 4 A composite according to the invention made of 55% PA binder fibers and 45% of glass fibers as the reinforcement fibers. Starting weight of the web was 1000 gram per m². The composite was molded according to the invention using 11 bars absolute of saturated steam for 9 sec. The final density of the formed polyamide reinforcement layer is 303 kg/m³.

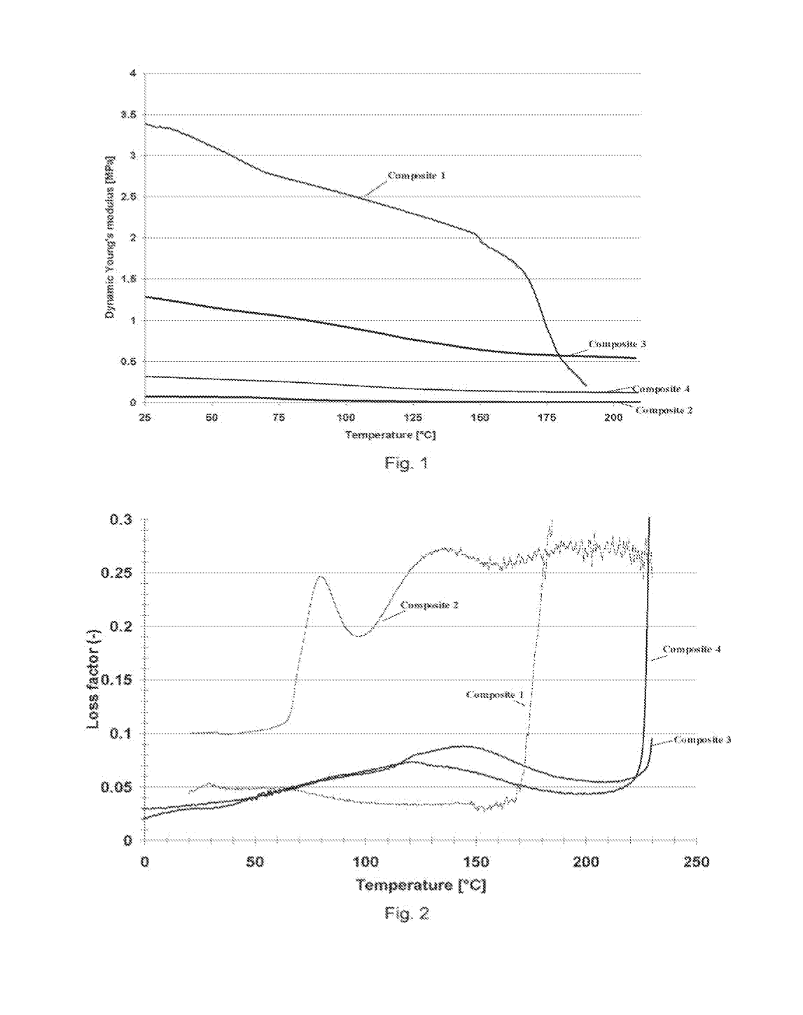

The dynamic young modulus over a temperature range was measured, and from this the tensile loss factor was calculated according to ISO 6721-4. The measurements and calculations were done using a 0.1 dB Metravib Viscoanalyser Type VA 2000. See FIGS. 1 and 2 for the results on all composites

For composite parts used in the automotive industry heat stability requirements are increasing. Particularly in the engine bay directly due to new motor generations generating more heat, as well as due to the option to keep the heat inside using isolation to optimise the overall use of fuel, leads to higher heat stability requirements. Normally the test for engine bay material is a long-term heat stability test at 120° C. or at 150° C. However, the actual temperature can rise easily to 180-190° C. for a short time. This temperature range can occur close or around hot engine sides, like exhaust line, manifold or compressors.

One requirement of the heat stability test is to know if the composite product keeps its form and shape during the exposure to heat. For instance, a parcel shelf placed under a sunny window should not sag after a while. An engine bay cover should keep its stiffness. The tensile loss factor over this temperature range is important for the stiffness retention of the product, when in use.

FIG. 1 shows the dynamic young modulus. Composite 1 the state of the art product based on a PP matrix and Glass fibers as reinforcement shows in absolute terms a higher modulus than composite 3 and 4 according to the invention. This is mainly due to the higher overall density. However, the trend is to obtain the same or better stiffness performance at a lower density saving weight in the car. More important however is that the state of the art composite 1 shows a significant loss of dynamic young modulus over the temperature range measured. Therefore, products made of combinations with PP tend to get softer at higher temperature. Composite 2 is a combination of CoPET/PET bicomponent binding fibers and cotton as the reinforcement material showing an overall too low dynamic young modulus to be self-supporting.

The composites per the invention show a much better behaviour over the temperature range measured. It was found that the dynamic young modulus of the polyamide reinforcement layer does not change more than 20% over a temperature range of 150° C. to 210° C. Rendering an overall more heat stable product.

FIG. 2 shows the tensile loss factor over the temperature range measured on the composite products. Composites 1 is state of the art based on polypropylene (PP) as matrix binder fiber produced with a molding method without steam. Although the products have a good loss factor up till 160° C., it rapidly loses its heat stability due to melting.

Composite 2 is a combination of CoPET/PET bicomponent binding fibers together with cotton as the reinforcement fibers. Therefore the bad loss factor over the measured temperature range is basically due to the CoPET, already softening at 80° C. and above 110° C. starting to melt. Although this is dependent on the CoPET used. Higher melting CoPET has other disadvantages including an increase in cost. In an absolute way, a composite material using PET alone would give a product with a good heat stability, it is not known today how this can be achieved, without heat damaging the reinforcement fibers due to the very high melting T needed.

Composite 3 and 4 are combinations of PA binder with glass fiber reinforcement fibers consolidated using steam according to the invention. Both have a stable tensile loss factor (−) of less than 0.15 over a temperature range of 60-210° C.

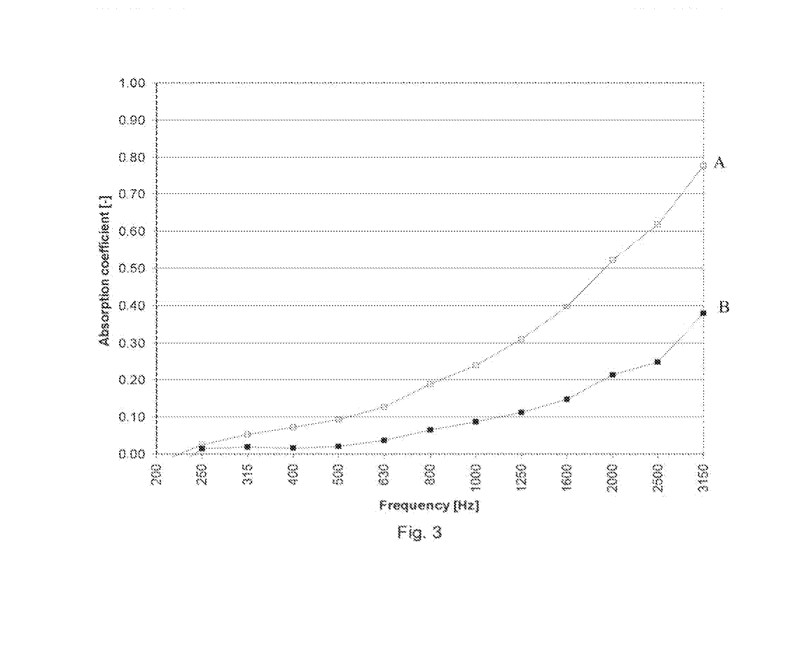

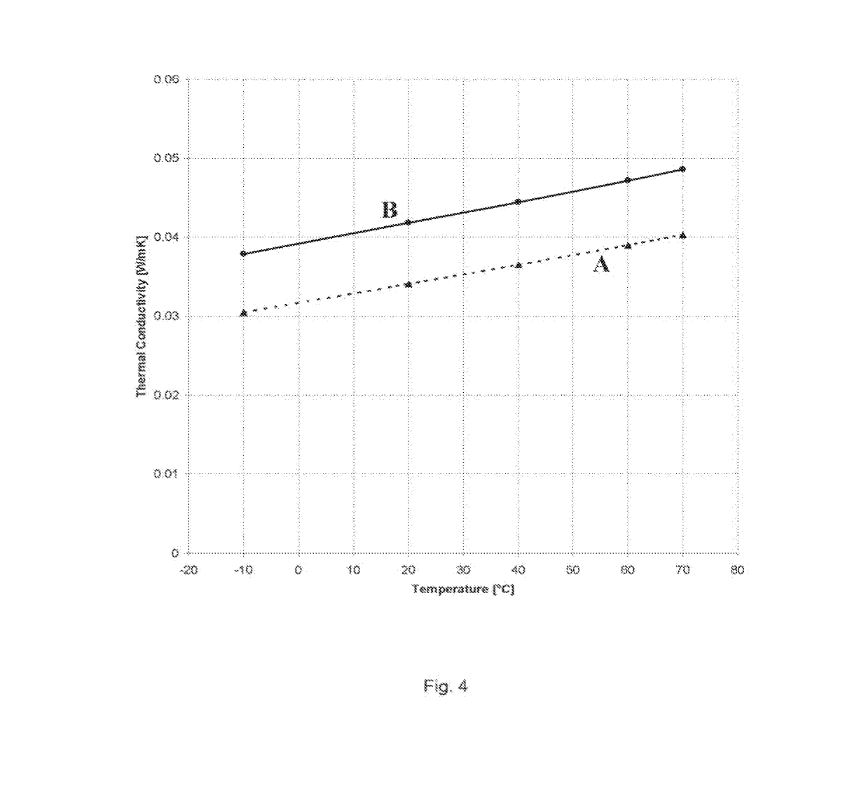

The polyamide reinforcement product can be compressed fully or partially to obtain a formed product. Due to the consolidation process using saturated steam according to the invention it is possible to obtain a product with a lower density and still obtain the wanted stiffness. Because the heating process using saturated steam melts the polyamide binder fibers at a much lower temperature than the thermoplastic reinforcement fibers, and all across the thickness at a nearly same time, the resilience on web structure of the reinforcement fibers can be kept. By reducing the amount of matrix forming polyamide to such a level that the overall product is just fully bonded, a porous reinforcement layer can be obtained with a density that is only 5 to 80% of the bulk density of the materials of the composite. However preferably a range from 5 to 60%, even more preferably 5 to 25% is obtainable and more advantages due to the lower costs of the overall part. Therefore, it is possible to obtain a product that is not solid but stays porous, rendering in a better acoustic absorber (see FIG. 3) due to the porosity of the material as well as a better thermal conductivity (see FIG. 4). By adjusting the density either by more compacting or by increasing the amount of PA matrix it is possible to adjust both the acoustic properties as well as the thermal conductivity.

Sample A and B were produced using the same web material of 65% Glass fibers and 35% PA binder fibers. Composite A was consolidated using the saturated steam according to the invention and Composite B was consolidated using compression between hot plates. Both were treated such that a fully bonded product was achieved.

The acoustic absorption properties of the composites formed were measured using an impedance-tube, according to the ASTM (E-1050) and ISO (10534-1/2) standards for impedance tube measurements (measurement between 200 and 3400 Hz). The thermal conductivity was measured using a guarded hot plate according to ISO8301.

The acoustic absorption and the thermal conductivity were found to be better in the steam treated product than in the hot plate treated product. This is partly due to the necessity to use more compression during the heating process using hot plates to obtain a fully bonded product. Therefore, obtaining a denser product B in the first place, hence a less porous product, showing a decrease in both thermal conductivity and acoustic property.

1. A method of producing a porous molded product, comprising:
randomly disposing polyamide-binding material, and a plurality of reinforcement fibers to form a web, the polyamide-binding material including at least one of fibers, flakes, and powder; and treating the web with pressurized saturated steam to consolidate the web.

2. The method of claim 1, wherein the pressurized saturated steam has a pressure in a range of 9 to 20 bars.

3. The method of claim 1, wherein the web is treated in a pressure resistant mold having at least one steam permeable surface forming the molded product.

4. The method of claim 1, wherein the web is pre-bonded before steam treatment.

5. A method for producing a porous molded product, comprising:
blending reinforcing fibers with a matrix;
placing the blend of reinforcing fibers and matrix into a mold such that a web is formed in the mold;
heating the web with saturated steam at a pressure of about 9-20 bars, the saturated steam being of a first temperature lower that the melting temperature of the matrix; and
melting the matrix as it is exposed to the first temperature.

6. The method of claim 5, wherein the matrix is comprised of at least one of polyamide fibers, powder of flakes.

7. The method of claim 5, wherein the web is formed by air lay, wet lay, or carding.

8. The method of claim 5, wherein the reinforcing fibers are comprised of a polymer having a melting temperature higher than that of the matrix.

9. The method of claim 5, wherein at least some of the plurality of reinforcing fibers cross each other to form at least one crossing point, and wherein the matrix only binds the at least one crossing points.

10. The method of claim 5, further comprising pre-binding the matrix and reinforcing fibers before the web is exposed to saturated steam.

11. The method of claim 5, wherein the matrix and reinforcing fibers are randomly disposed in the web.

12. The method of claim 5, wherein the reinforcing fibers is comprised of at least one of glass fibers and polyethylene terephthalate (PET) fibers.

13. The method of claim 5, wherein the reinforcing fibers is comprised of polyethylene terephthalate (PET) fibers, wherein the melting point of the reinforcing fibers is similar to the melting point of the matrix, and wherein the reinforcing fibers remains in a fibrous state when exposed to saturated steam.
